(19) United States
(12) Patent Application Publication
(10) Pub. No.: US 2018/0043843 A1
(43) Pub. Date: Feb. 15, 2018

(54) METHODS AND SYSTEMS FOR PREVENTING CONTAMINATION OF EMERGENCY VEHICLES

(71) Applicants: Frederick J. TROTTA, Guilford, CT (US); Kenneth R. HORTON, Guilford, CT (US); Leonard GUERCIA, Wallingford, CT (US); Robert HOLDSWORTH, Colchester, CT (US); Martin KELLEHER, Guilford, CT (US)

(72) Inventors: Frederick J. TROTTA, Guilford, CT (US); Kenneth R. HORTON, Guilford, CT (US); Leonard GUERCIA, Wallingford, CT (US); Robert HOLDSWORTH, Colchester, CT (US); Martin KELLEHER, Guilford, CT (US)

(21) Appl. No.: 15/559,730

(22) PCT Filed: Mar. 18, 2016
(86) PCT No.: PCT/US2016/023168

§ 371 Date: Sep. 19, 2017

Related U.S. Application Data
(60) Provisional application No. 62/135,815, filed on Mar. 20, 2015.

(51) Int. Cl. B60R 13/01

(52) U.S. Cl. CPC B60R 13/011; B60Y 2410/113; B60Y 2200/116; B60R 2013/018

(57) ABSTRACT

A liner for installation in an interior space of an emergency vehicle to prevent surface contamination. The liner is secured with a system of grommets and clips, allowing the liner to be easily installed when needed and removed after use. The liner is designed to be easily installable and disposable, while enabling medical staff to operate within the emergency vehicle essentially unhindered by its presence. In some embodiments, the liner is stored in a container under put into use and then disposed of in that same container.

### CROSS-REFERENCE TO RELATED APPLICATIONS

This application is a National Stage filing of International Patent Application No. PCT/US2016/023168, filed Mar. 18, 2016, which claims the benefit of priority to U.S. Provisional Patent Application No. 62/135,815, entitled “Methods and Systems for Preventing Contamination of Emergency Vehicles”, filed Mar. 20, 2015, the entire disclosures of which are hereby incorporated by reference herein.

### BACKGROUND

Each day, emergency medical services professionals around the world respond to the medical needs of the sick and injured. The patients attended to by these medical professions and staff may be infected by a contagious disease, and working in such close proximity with infected individuals on such a regular basis greatly increases the likelihood that the medical staff would become infected themselves. It is of high importance, therefore, that safety measures be put in place for the safety of these medical workers.

One way of limiting the spread of infectious disease such as the flu, Ebola, and the like is by limiting or avoiding exposure to the patient's blood and other bodily fluids. In high use medical environments, such as ambulances and other medical vehicles, there is a concerted effort to maintain as close to a sterile working environment as possible for the medical staff. Unfortunately, due to the hectic nature of emergency medicine and medical staffs intense focus on the patient, even the most ardent efforts to maintain a sterile environment can become inadequate over time and open these individuals up to infection not necessarily from the patient at hand, but a patient who is no longer even in the area.

What is desired, therefore, is a system that allows for medical staff to maintain a high level of cleanliness within an emergency vehicle such as an ambulance, and further is easy to implement and reuse for the next patient after it becomes contaminated by a previous patient.

### SUMMARY

In some embodiments, the present disclosure is directed to a system for preventing contamination of interior surfaces of an emergency vehicle comprising a liner including a plurality of surfaces and a plurality of grommets on said plurality of surfaces, said plurality of surfaces being configured so as to substantially cover said interior surfaces of said emergency vehicle, a plurality of clips for releasably joining said liner with said interior surfaces of said emergency vehicle via said plurality of grommets, and a container including a bio-bag for containing said liner when in both a first collapsed position prior to installation in said emergency vehicle and a second collapsed position after removal from said emergency vehicle. In some embodiments, the container is disposable.

In some embodiments, the liner includes 6 mil rolled plastic. In some embodiments, the liner includes a top surface, at least one side surface, and at least one interface between said top surface and said at least one side surface, wherein at least one of said plurality of grommets is positioned on said top surface, along at least one of said at least one interface, at least one side surface, and at least one corner between said top and side surfaces. In some embodiments, the liner includes a bottom surface, at least one side surface, and at least one interface between said bottom surface and said at least one side surface, wherein at least one of said plurality of grommets is positioned on said bottom surface, along at least one of said at least one interface, at least one side surface, and at at least one corner between said bottom and side surfaces. In some embodiments, the top surface, at least one side surface, at least one interface, and at least one corner allow said liner to substantially follow the contours of said interior surfaces of said emergency vehicle.

In some embodiments, one of the side surfaces is a flap substantially unconnected to another side surface for protecting rear doors of said emergency vehicle.

In some embodiments, the present disclosure is directed to a method for preventing contamination of an interior of an emergency vehicle comprising the steps of providing a container containing a bio-bag, said container comprising a liner contained therein, removing said liner from said container, pulling an end of said liner through an opening in said emergency vehicle, positioning an opposing end of said liner adjacent said opening, clipping said liner to an interior surface of said emergency vehicle via a plurality of clips and grommets, unclipping said clips, grommets, and liner from said interior surface, returning said clips, grommets, and liner to said bio-bag, and disposing of said container. In some embodiments, the step of clipping said liner to an interior surface of said emergency vehicle provides 360 degree protection to said interior of the emergency vehicle.

In some embodiments, the opposing end includes a flap substantially covering said opening. In some embodiments, the opening is a back door of said emergency vehicle.

### BRIEF DESCRIPTION OF THE DRAWINGS

The following figures are illustrative only and are not intended to be limiting.

FIG. 1 portrays a liner for preventing contamination of interior surfaces of an emergency vehicle.

FIG. 2 portrays a method for using the liner identified in FIG. 1.

### DESCRIPTION

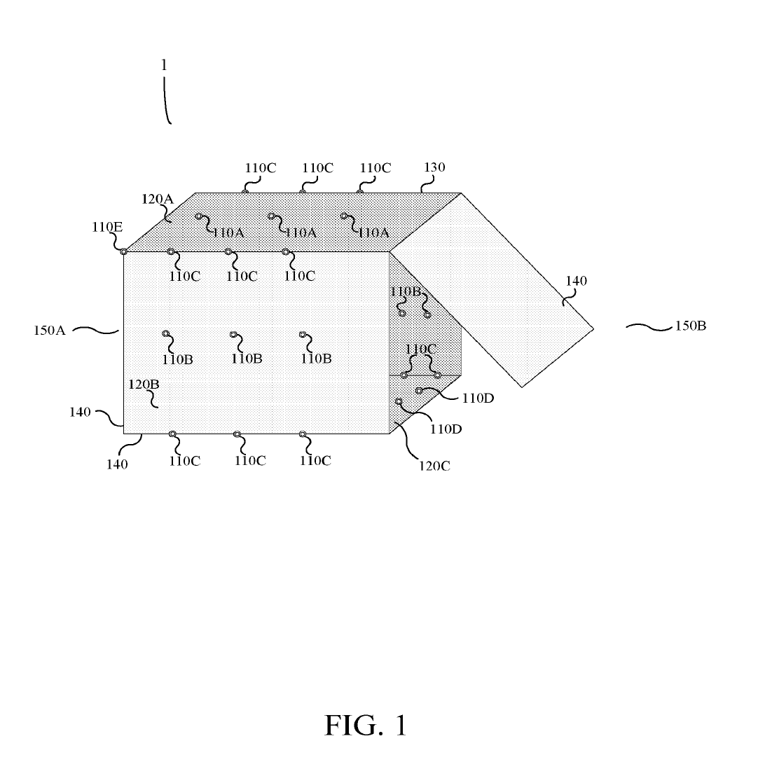

Referring now to FIG. 1, in some embodiments, the system for preventing contamination of interior surfaces of an emergency vehicle comprises a liner 1 having a plurality of surfaces. In some embodiments, the plurality of surfaces cover interior surfaces of the emergency vehicle. In some embodiments, the plurality of surfaces cover the entirety of interior surfaces of the emergency vehicle. In some embodiments, the plurality of surface follow and mirror the contours of the interior surfaces of the emergency vehicle. In some embodiments, the plurality of surfaces provide 360 degrees of protection around a user inside the emergency vehicle. In some embodiments, liner 1 comprises a top surface 120A. In some embodiments, liner 1 comprises a bottom surface 120C. In some embodiments, liner 1 comprises at least one side surface 120B. In some embodiments, there are interfaces 130 between at least two of the above-identified surfaces. One embodiments, there is an interface between a top surface 120A and a side surface 120B. In some embodiments, there is an interface between a side surface 120B and a bottom surface 120C. In some embodiments, liner 1 is a polyhedron. In some embodiments, liner 1 is a rectangular prism. In some embodiments, liner 1 is a triangular prism. In some embodiments, liner 1 is a tetrahedron. In some embodiments, liner 1 is conical. In some embodiments, liner 1 is made from a durable, synthetic material. In some embodiments, liner 1 is made from plastic. In some embodiments, liner 1 is made from 6 mil rolled plastic. In some embodiments, the liner is disposable. In some embodiments, liner 1 is expandable to fit a plurality of interior space sizes.

In some embodiments, liner 1 is connected to another surface via grommets located on the outer surfaces of the liner. In some embodiments at least one grommet is located on the top surface 120 A (grommet 110A). In some embodiments, at least one grommet is located on a side surface 120B (grommet HOB). In some embodiments, at least one grommet is located on a bottom surface 120C (grommet HOD). In some embodiments, at least one grommet is located on an interface 140 (grommet 1 IOC). In some embodiments, at least one grommet is located at a corner of liner 1 (grommet 110E). In some embodiments, there are any number of grommets necessary to provide sufficient space for medical staff to operate in the interior of the emergency vehicle.

In some embodiments, the grommets interact with clips to attach to another surface. In some embodiments, the other surface is an interior surface of an emergency vehicle. In some embodiments, the clips are designed to be disposed with liner 1. In some embodiments, there are any number of clips necessary to provide sufficient space for medical staff to operate in the interior of the emergency vehicle. In some embodiments, the clips releasably interact with the grommets described above. In some embodiments, the clips releasably interact with the interior surface of the emergency vehicle.

In some embodiments, liner 1 is packaged in a container. In some embodiments, the container also contains a bio-bag. In some embodiments, liner 1 is also packaged within the bio-bag. In some embodiments, the container and bio-bag are designed as receptacles for used liners. In this embodiment, once a user desired to dispose of liner 1, it is placed back into the bio-bag and is able to be disposed of consistent with the relevant waste disposal guidelines. In some embodiments, liner 1 is packaged in a collapsed confirmation. In some embodiments, liner 1 is disposed of in a collapsed confirmation. In some embodiments, the first or “packaged” collapsed conformation is not the same as the second or “disposed of collapsed conformation. In some embodiments, the first and second collapsed conformations are substantially the same.

In some embodiments, one of the side surfaces 120B is a flap 140. In some embodiments, there is an interface between flap 140 and at least one of the surfaces identified above. In some embodiments, flap 140 is substantially unconnected to any other side surfaces 120B. In some embodiments, flap 140 is of a single piece construction. In some embodiments, flap 140 is composed of a series of smaller flaps. In some embodiments, flap 140 is a barrier between an interior of the emergency vehicle and an exterior of the emergency vehicle. In some embodiments, flap 140 substantially covers an opening in the emergency vehicle. In some embodiments, the opening in the emergency vehicle is the rear door of the emergency vehicle.

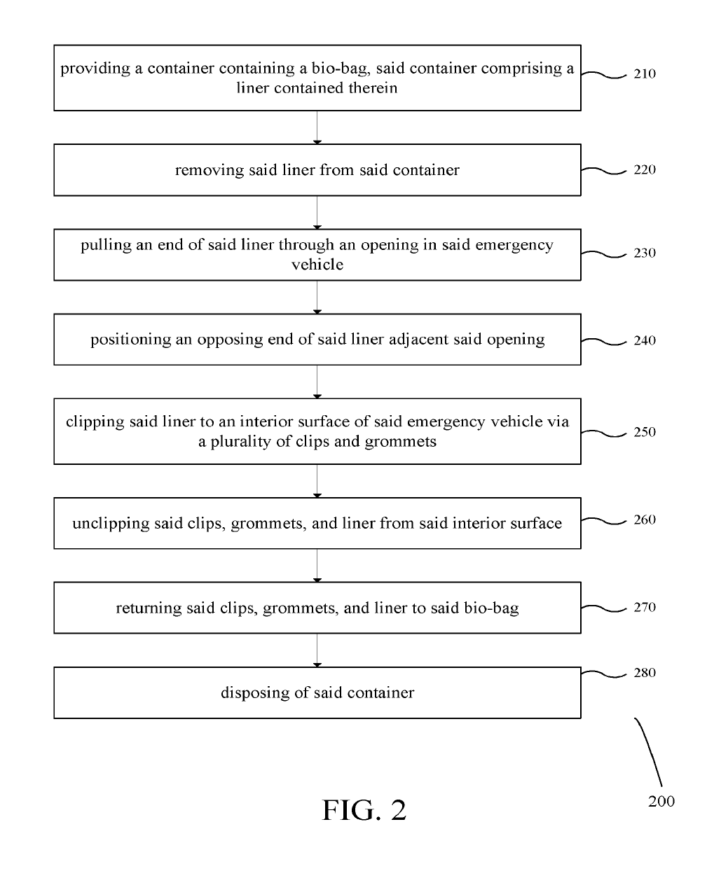

In some embodiments, the present disclosure is directed to a method 200 of using liner 1. Referring now to FIG. 2, the method includes the step of providing 210 a container containing a bio-bag, the container having the liner therein. The liner is then removed 220 from the container. An end (see 150A from FIG. 1) is then pulled 230 through an opening in the emergency vehicle. In some embodiments, the opening in the emergency vehicle is the rear door of the emergency vehicle. The opposing end (see 150B from FIG. 2) is then positioned 240 adjacent the opening. The liner is then clipped 250 to an interior surface of the emergency vehicle via clips and grommets as discussed above.

Now installed, medical staff and patients may enter the emergency vehicle through the opposing end 150B, yet the interior surfaces of the vehicle are protected from contamination. Once a user desires to dispose of liner 1, it is undipped 260 from the interior surface that it is connected to and returned 270 to the container. In some embodiments, the grommets and clips are returned to the container as well. In some embodiments, the items to be disposed of are first placed in the bio-bag and then placed in the container. Finally, the container is disposed of 280.

Although the invention has been described and illustrated with respect to exemplary embodiments thereof, it should be understood by those skilled in the art that the foregoing and various other changes, omissions and additions may be made therein and thereto, without parting from the spirit and scope of the present invention. Accordingly, other embodiments are within the scope of the following various embodiments.

1-7. (canceled)

8. A method for preventing contamination of an interior of an emergency vehicle comprising:
providing a container containing a bio-bag, said container comprising a liner contained therein;
removing said liner from said container;
pulling an end of said liner through an opening in said emergency vehicle; positioning an opposing end of said liner adjacent said opening; clipping said liner to an interior surface of said emergency vehicle via a plurality of clips and grommets;
unclipping said clips, grommets, and liner from said interior surface; returning said clips, grommets, and liner to said bio-bag; and
disposing of said container.

9. The method for preventing contamination of interior surfaces of an emergency vehicle according to claim 1, wherein said opposing end includes a flap substantially covering said opening.

10. The method for preventing contamination of interior surfaces of an emergency vehicle according to claim 1, wherein said opening is a back door of said emergency vehicle.

11. The method for preventing contamination of interior surfaces of an emergency vehicle according to claim 1, wherein the step of clipping said liner to an interior surface of said emergency vehicle provides 360 degree protection to said interior of the emergency vehicle.
